(19) United States
(12) Patent Application Publication
(10) Pub. No.: US 2023/0187100 A1
(43) Pub. Date: Jun. 15, 2023

(54) ELECTRICAL HARNESS FOR A COMPOSITE OBJECT

(71) Applicant: FAURECIA SYSTEMES D'ECHAPPEMENT, Nanterre (FR)

(72) Inventors: Aldric MOUSSIER, BURNHAUPT LE BAS (FR); Guillaume TOMATIS, CHAUX (FR); Eunji WALGENWITZ, COURMONT (FR); Mohamed BOUICH, SELONCOURT (FR)

(21) Appl. No.: 18/076,585

(22) Filed: Dec. 7, 2022

(30) Foreign Application Priority Data
Dec. 9, 2021 (FR) 21 13206

(51) Int. Cl. H01B 7/00; H01B 7/04; F17C 13/02

(52) U.S. Cl. CPC H01B 7/0045; H01B 7/04; F17C 13/02; F17C 2250/0491; F17C 2201/0109

(57) ABSTRACT

An electrical harness for a composite object comprises a first electrical layer mainly embedded in the composite of the object, a second electrical layer mainly outside the composite of the object, and a connection device electrically connecting the first layer and the second layer.

### CROSS-REFERENCE TO RELATED APPLICATION

This application is a U.S. non-provisional application claiming the benefit of French Application No. 21 13206, filed on Dec. 9, 2021, which is incorporated herein by reference in its entirety.

### TECHNICAL FIELD

The disclosure relates to an electrical harness for a composite object.

### BACKGROUND

It is known to make an electrical harness in order to connect one or more electrical or electronic components, with a power source and/or a processing unit.

More particularly, for a composite object, which one wishes to equip with at least one electrical and/or electronic component, it is known to use an electrical harness to connect said at least one electrical and/or electronic component.

The said at least one electrical and/or electronic component is mounted integral with the composite object, preferably embedded in the composite. The harness connects said at least one electrical and/or electronic component to a power supply and/or processing unit arranged outside the composite.

An electrical harness with this configuration also comprises at least one inner layer, embedded in the composite, so as to reach and connect the at least one electrical and/or electronic component, and at least one outer layer, outside of the composite, so as to reach and connect the electrical supply and/or the processing unit.

However, the inner and outer layers are subject to different and sometimes incompatible constraints.

Thus, the inner layer is in contact with the composite or, preferably, mostly embedded in the composite. It is therefore advantageous that the material ensuring the protection of the outer surface of the inner layer is compatible with the material constituting the composite matrix, so that these two materials in contact are adhered to each other, in order not to cause delamination at their interface. Advantageously, the inner layer is protected, in the part where it is embedded, from the stresses of the external environment, by the composite.

On the other hand, the outer layer is subject to the stresses of the external environment, particularly humidity and/or temperature. Thus, the outer layer may need to be tropicalized. Depending on the case, the outer layer is also subject to the constraints of the electronics in that it needs to accommodate surface-mounted components and/or a printed circuit, integrated into the layer itself.

These constraints are difficult to reconcile and the search for the same protective material to make the inner and outer layers leads to a poor compromise, satisfying neither the internal nor the external constraints.

### SUMMARY

There are materials that are well adapted to the stresses experienced by the inner layer and materials that are well adapted to the stresses experienced by the outer layer.

The disclosure therefore proposes a solution that takes advantage of the best of both worlds.

To this end, the disclosure has as its object an electrical harness for a composite object, comprising a first electrical layer mostly embedded in the composite of the object, a second electrical layer mostly outside the composite of the object, and a connection device, electrically connecting the first layer and the second layer.

Particular features or embodiments, usable alone or in combination, are:

the first layer comprises at least a first flexible conductor, wrapped in a first flexible envelope made of a plastic material compatible with the composite of the object, such as an epoxy, aramid or thermoplastic matrix composite, reinforced with glass or aramid fibers,

the second layer comprises at least one second flexible conductor, wrapped in a second flexible envelope made of a plastic material compatible with the constraints of electronics and tropicalization, such as a polyethylene terephthalate or PET, a polyethylene or PE, or a polyimide, such as a linear polyimide or PI, a thermoplastic polyimide or TPI, a poly bismaleimide or BMI, or a polyimide for polymerization of monomer reagents or PMR,

the connection device comprises a first connector connected to said at least one first conductor of the first layer and a second connector, complementary to the first connector, connected to said at least one second conductor of the second layer,

the connection device comprises an end of the first layer revealing said at least one first conductor and an end of the second layer revealing said at least one second conductor, in such a way that the first conductor and the second conductor are capable of being assembled together to make the connection,

the connection device is embedded in the composite of the object,

the connection device is outside the composite of the object,

the connection device is protected by an epoxy coating and/or by a housing,

the first layer comprises at least two ends emerging from the composite of the object, preferably arranged on either side of the object,

the first layer further comprises and further connects at least one sensor embedded in the composite of the object,

the second layer further comprises at least one electronic component, mounted on the surface of the second layer.

In a second aspect of the disclosure, a reservoir or tank for pressurized gas comprises a composite structure and at least one such harness, the composite object being the composite structure.

Particular features or embodiments, usable alone or in combination, are:

said at least one harness, comprises at least one first harness including and connecting at least one sensor of a first zone of the reservoir or tank and at least one second harness including and connecting at least one sensor of a second zone of the reservoir or tank,

the reservoir or tank presents a longitudinal extension; the first zone covers the left half of the tank and the at least one first harness emerges from the composite of the structure at the left end of the tank and the second zone covers the right half of the tank and the said at least one second harness emerges from the composite of the structure at the right end of the tank.

### BRIEF DESCRIPTION OF THE DRAWINGS

The disclosure will be better understood from the following description, made only by way of example, and with reference to the appended figures in which:

FIG. 1 shows a composite object equipped with a harness according to a first embodiment of the disclosure, not connected;

FIG. 2 shows the object of FIG. 1, with the harness connected;

FIG. 3 shows a composite object equipped with a harness according to another embodiment of the disclosure;

FIG. 4 shows, in profile view, a detail of one embodiment of a connection device;

FIG. 5 shows, in perspective view, a tank, in the course of manufacture, with a first layer;

FIG. 6 shows, in perspective view, the finished tank of FIG. 5;

FIG. 7 shows, in perspective view, a harness comprising a layer including two ends;

FIG. 8 shows, in perspective view, a harness branching into three layers, covering three zones; and

FIG. 9 shows, in a partially cut perspective view, a housing protection.

### DETAILED DESCRIPTION

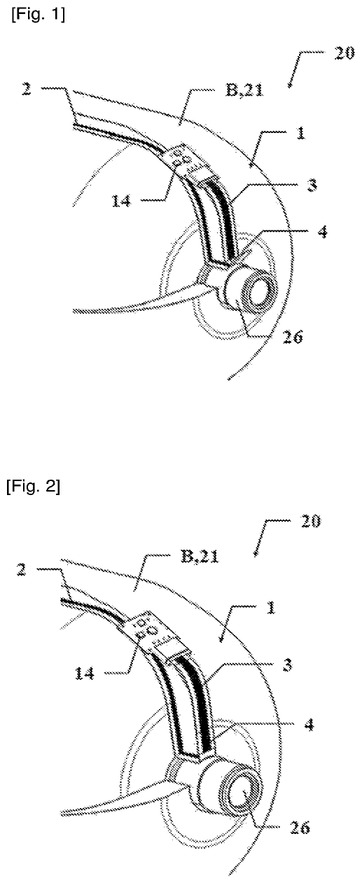

The disclosure relates to an electrical harness 1 for a composite object B. As illustrated in FIGS. 1 to 3, such a harness 1 comprises a first electrical layer 2, mostly embedded in the composite of the object B, a second layer 3 mostly outside the composite of the object B. According to one feature, a connection device 4 electrically connects the first layer 2 and the second layer 3.

Such an embodiment is advantageous in that it allows the first layer 2 to be produced as a function of its own constraints, mainly related to integration with the composite, and the second layer 3 to be produced as a function of its own constraints, mainly related to resistance to external environmental conditions.

According to another characteristic, the first layer 2 comprises at least one first flexible conductor 5 (see FIG. 4). This at least one first conductor 5 is, for reasons of mechanical protection and electrical insulation, wrapped in a first flexible envelope 6. This second envelope 6 is made of a plastic material compatible with the composite of the object B. Compatibility with the composite is understood to mean the possibility of fusing or at least adhering to the composite. According to one possible embodiment, the envelope 6 is made of an epoxy or thermoplastic matrix composite, reinforced with glass or aramid fibers.

According to another feature, the second layer 3 comprises at least one second flexible conductor 7 (see FIG. 4). This at least one second conductor 7 is, for reasons of mechanical protection and electrical insulation, wrapped in a second flexible envelope 8. This second envelope 8 is made of a plastic material compatible with the constraints of electronics and of tropicalization. Compatibility with the constraints of electronics means protection of the conductor 7 against contact, namely, electrical insulation, as well as the possibility of integrating electronic components 14 in the second layer 3. Tropicalization means protecting the conductor 7 from environmental temperature and humidity variations. This can be achieved by a material conventionally used for this purpose: polyimide, polyethylene terephthalate or polyethylene. An advantage of the disclosure is that pre-existing layers can be reused. Polyimide comprises all polyimides: linear polyimide or PI, thermoplastic polyimide or TPI, poly bismaleimide or BMI or even polymerization of monomer reagents polyimide or PMR.

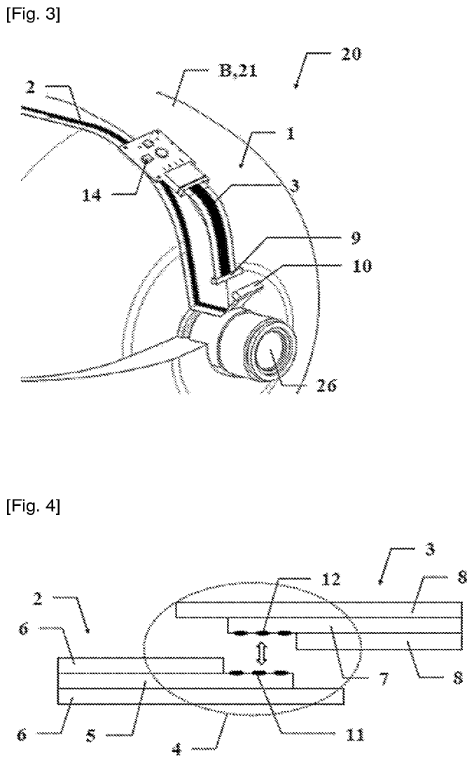

According to another feature, the connection device 4 comprises, as illustrated in FIG. 3, a connector 9, 10 on each layer 2, 3. Thus, a first connector 9 is connected to said at least one first conductor 5 of the first layer 2 and a second connector 10, complementary, in that it can be connected with the first connector 9, is connected to said at least one second conductor 7 of the second layer 3. Thus, each of the layers 2, 3 is in place, the first layer 2 in the composite and the second layer 3 on the outside, so that their ends are located close to each other. The two layers 2, 3 are then connected to each other by connecting the two connectors 9, 10.

According to another feature, the ends of the two layers 2, 3 are directly assembled together, as illustrated in FIG. 2. Thus, a first end 11 (see FIG. 4) of the first layer 2 is prepared in such a way as to reveal the said at least one first conductor 5. Similarly, a second end 12 of the second layer 3 is prepared to reveal said at least one second conductor 7. For each of the two conductors 5, 7, the envelope 6, 8 which protects it is locally removed so as to allow the conductor 5, 7 to emerge in order to be able to make the connection by placing the conductors 5, 7 in contact. This makes it possible to make a connection by gluing, welding, screwing, braiding, clipping or any other similar method of assembling a first conductor 5 with a second, homologous conductor 7.

As illustrated in FIG. 4, the envelopes 6, 8 are shaped in a complementary manner, so as to overlap each other and advantageously interlock, in order to fully protect the conductors 5, 7 and their assembly.

The assembly of the conductors 5, 7 between them can be done end to end or face to face.

The connection device 4 is made at the interface between the two layers 2, 3. It is therefore located not far from the interface between the composite and the outside.

According to another feature, the connection device 4 is embedded in the composite of the object B. Such a configuration is advantageous in that the connection device 4 is thus protected, by its insertion in the composite. The disadvantage is that, although low, part of the second layer 3 is embedded in the composite, although it is not necessarily suitable for it.

According to another feature, the connection device 4 is outside the composite of the object B. Such a configuration presents the disadvantage of not protecting the connection device 4. It is advantageous in that the second layer 3 is not integrated into the composite. As such, it can only be added afterwards. It is thus possible to produce the composite of part B with only the first layer 2. This makes it possible not to apply the mechanical and/or thermal stresses caused by the manufacture of the composite of part B to the second layer 3.

As seen previously, in the case where the connection device 4 is not integrated into the composite, it is preferable to protect the connection device 4. According to another feature, not illustrated, the junction between the two layers 2, 3 can be protected by a coating, preferably of epoxy resin. Alternatively, or additionally, as illustrated in FIG. 9, protection can be provided by a housing 15, enveloping the junction between the two layers 2, 3.

According to another feature, the first layer 2, intended to be integrated into the composite, is shaped so as to comprise at least two ends emerging from the composite of the object B. At least one of these two ends participates in the junction at the connection device 4. The other end(s) may participate in another connection device 4 or may be solely used to grip the first layer 2. Thus, the first layer 2 advantageously comprises at least two gripping structures. These gripping structures advantageously make it possible to hold the first layer 2 in position, in particular during the production of the composite of the object B, for example by filament winding. The said at least two ends are preferably arranged on either side of the object B.

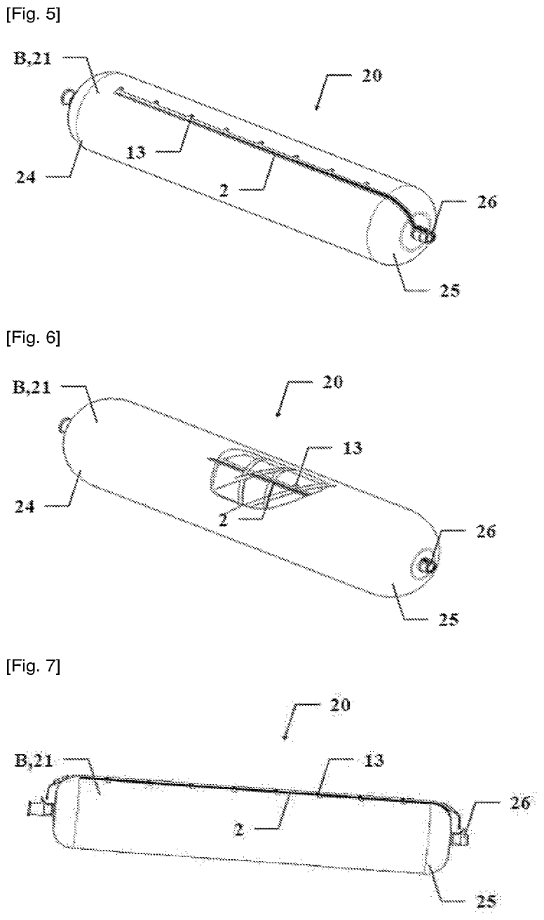

According to another feature, more particularly illustrated in FIGS. 5 and 6, the first layer 2 further comprises and connects at least one sensor 13 embedded in the composite of object B. Such a sensor 13 may, for example, be a deformation sensor of the object composite B. Such a deformation sensor 13 is advantageous for ensuring safety functions for a gas tank 20.

According to a further feature, more particularly illustrated in FIGS. 1 to 3, the second layer 3 further comprises at least one electronic component 14, mounted on the surface of the second layer 3. This is made possible by the adaptation of the second layer 3 to the constraints of the electronics and by the fact that the second layer 3 is located outside the composite.

The disclosure further relates to a reservoir or tank 20 for pressurized gas. Such a tank is of the type comprising a composite structure 21. This structure 21 advantageously accommodates at least one harness 1, as previously described.

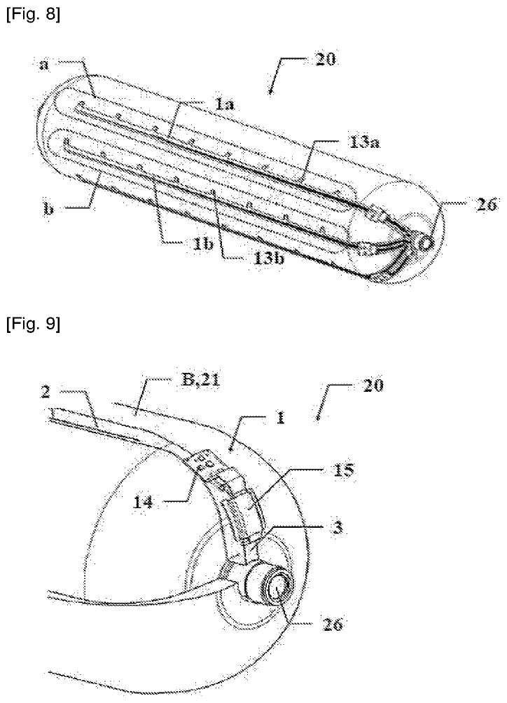

According to another feature, more particularly illustrated in FIG. 8, the tank 20 comprises at least a first harness 1a comprising and connecting at least one sensor 13a of a first zone a of the tank 20 and at least one second harness 1b comprising and connecting at least one sensor 13b of a second zone b of the tank 20.

Such a feature, advantageously, allows the harness 1a, 1b to be specialized by zone, in order to shorten the distances between sensors 13a, 13b and a processing unit. This is particularly advantageous for long and/or large diameter tanks 20.

The connection device 4 are preferably arranged at the ends 24, 25 of a tank 20, close to a base 26.

According to another feature, not shown, the reservoir or tank 20 presents a longitudinal extension. The first zone a preferably covers the left half of the tank 20 and the said at least one first harness 1a emerges out of the composite of the structure 21 at the left end 24 of the tank 20 and the second zone b covers the right half of the tank 20 and the said at least one second harness 1b emerges out of the composite of the structure 21 at the right end 25 of the tank 20.

The disclosure has been illustrated and described in detail in the drawings and the preceding description. The latter should be considered illustrative and given by way of example and not as limiting the disclosure to this description alone. Many alternative embodiments are possible.

### LIST OF REFERENCE SIGNS

a, b: zone,

1, 1a, 1b: harness,

2: first layer (embedded),

3: second layer (outer),

4: connection device,

5: first conductor,

6: first envelope,

7: second conductor,

8: second envelope,

9: first connector,

10: second connector,

11: first end,

12: second end,

13, 13a, 13b: sensor,

14: electronic component,

15: housing,

20: tank,

21: structure,

22: end,

23: end,

24: left end,

25: right end,

26: base.

1. An electrical harness for an object made of a composite comprising:
a first electrical layer mostly embedded in the composite of the object;
a second electrical layer mostly outside the composite of the object; and
a connection device electrically connecting the first electrical layer and the second electrical layer.

2. The electrical harness according to claim 1, wherein the first electrical layer comprises at least a first flexible conductor, wrapped in a first flexible envelope made of a plastic material compatible with the composite of the object.

3. The electrical harness according to claim 2, wherein the plastic material of the first flexible envelope is an epoxy or thermoplastic matrix composite, reinforced by glass or aramid fibers.

4. The electrical harness according to claim 1, where the second electrical layer comprises at least a second flexible conductor, wrapped in a second flexible envelope made of a plastic material compatible with constraints of electronics and tropicalization.

5. The electrical harness according to claim 4, wherein the plastic material of the second flexible envelope is polyethylene terephthalate or PET, polyethylene PE or polyimide, such as linear polyimide or PI, thermoplastic polyimide or TPI, poly bismaleimide or BMI or polymerization of monomer reagent polyimide or PMR.

6. The electrical harness according to claim 2, wherein the connection device comprises a first connector connected to said at least one first flexible conductor of the first electrical layer, and wherein, the second electrical layer comprises at least a second flexible conductor, wrapped in a second flexible envelope made of a plastic material compatible with constraints of electronics and tropicalization, and wherein the connection device comprises a second connector, complementary to the first connector, connected to said at least one second flexible conductor of the second electrical layer.

7. The electrical harness according to claim 2, wherein the connection device comprises an end of the first electrical layer revealing said at least one first flexible conductor, and wherein, the second electrical layer comprises at least a second flexible conductor, wrapped in a second flexible envelope made of a plastic material compatible with constraints of electronics and tropicalization, and wherein the connection device comprises an end of the second electrical layer revealing said at least one second flexible conductor, such that the first conductor and the second conductor are suitable to be assembled together to make a connection.

8. The electrical harness according to claim 1, wherein the connection device is embedded in the composite of the object.

9. The electrical harness according to claim 1, wherein the connection device is outside the composite of the object.

10. The electrical harness according to claim 9, wherein the connection device is protected by an epoxy coating and/or by a housing.

11. The electrical harness according to claim 1, wherein the first electrical layer comprises at least two ends emerging from the composite of the object.

12. The electrical harness according to claim 11, wherein the at least two ends are arranged on either side of the object.

13. The electrical harness according to claim 1, wherein the first electrical layer further comprises and connects at least one sensor embedded in the composite of the object.

14. The electrical harness according to claim 1, wherein the second electrical layer further comprises at least one electronic component, mounted on a surface of the second electrical layer.

15. A tank for pressurized gases, comprising a composite structure, wherein the tank further comprises at least one electrical harness according to claim 1, where the composite object is the composite structure.

16. The tank according to claim 15, wherein said at least one electrical harness comprises at least a first electrical harness including and connecting at least one first sensor of a first zone of the tank and at least a second harness including and connecting at least one second sensor of a second zone of the tank.

17. The tank according to claim 16, presenting a longitudinal extension, wherein the first zone covers a left half of the tank and said at least one first harness emerges from the composite of the composite structure at a left end of the tank and the second zone covers a right half of the tank and said at least one second harness emerges from the composite of the composite structure at a right end of the tank.
